(19) United States
(12) Patent Application Publication
(10) Pub. No.: US 2024/0308283 A1
(43) Pub. Date: Sep. 19, 2024

(54) HEIGHT-ADJUSTABLE HITCH SYSTEM FOR TRAILER

(71) Applicant: Robert T. Filson, Hendersonville, TN (US)

(72) Inventor: Robert T. Filson, Hendersonville, TN (US)

(21) Appl. No.: 17/803,943

(22) Filed: May 21, 2024

Related U.S. Application Data
(60) Provisional application No. 63/361,975, filed on Feb. 1, 2022.

(51) Int. Cl. B60D 1/46; B60D 1/06

(52) U.S. Cl. CPC B60D 1/46; B60D 1/06

(57) ABSTRACT

A hitch system for hitching a trailer to a pulling vehicle having a ball mount and wherein the trailer includes a ball-accepting coupler includes a sleeve member which defines an elongated guideway having two opposite ends and which is supported by the trailer in an angular relationship with respect to the horizontal. The hitch system also includes a V-shaped adapter having a first portion which cooperates with the guideway for movement between the opposite ends thereof and a second portion which is adapted to support a ball-accepting coupler so that by securing the ball-accepting coupler to the second portion of the adapter and moving the first portion of the adapter along the length of the guideway, the ball-accepting coupler can be positioned at any of a number of alternative horizontal levels relative to the ball mount to facilitate the coupling of the ball-accepting coupler to the ball mount.

The benefit of Provisional Application Ser. No. 63/361,975, filed Feb. 1, 2022 and entitled TRAILER WITH HEIGHT-ADJUSTABLE HITCH SYSTEM, is hereby claimed. The disclosure of this referenced provisional application is incorporated herein by reference.

### BACKGROUND OF THE INVENTION

This invention relates generally to trailers capable of being pulled behind a vehicle, such as a pick-up truck, tractor or all-terrain vehicle, and relates, more particularly, to means and methods by which such a trailer is hitched to a vehicle for trailer-pulling purposes.

There exists trailer hitch assemblies which include a ball mount which is mounted upon the rear of a pulling vehicle and a ball-accepting coupler assembly which is associated with the trailer to be pulled. By securing, or coupling, the coupler assembly about the ball of the ball mount, the trailer is attached to the pulling vehicle for trailer-pulling purposes.

When a user attempts to hitch the coupler assembly of the pulling vehicle to the ball mount associated with the trailer, it is not uncommon for the user to discover that the ball mount and the coupler assembly are disposed at appreciably-different horizontal levels. Such an appreciable difference in the horizontal disposition between the ball mount and the coupler assembly of the trailer to be pulled can render it quite difficult to secure, or couple, the coupler assembly to the ball mount.

It would be desirable to provide a hitch system which facilitates the hitching of the coupler assembly of a trailer to a ball mount associated with a pulling vehicle, even though the coupler assembly of the trailer and the ball mount of the pulling vehicle may be disposed at appreciably different horizontal levels.

Accordingly, it is an object of the present invention to provide a new and improved hitch system which facilitates the hitching of a coupler assembly of a trailer to a ball mount associated with a pulling vehicle used for pulling a trailer.

Another object of the present invention is to provide such a hitch system which is well-suited for use with a trailer to be pulled behind a vehicle.

Still another object of the present invention is to provide such a trailer hitch system which is uncomplicated in structure, yet effective in operation.

### SUMMARY OF THE INVENTION

This invention resides in a hitch system for hitching a trailer to a pulling vehicle wherein the trailer includes a wheeled frame having a forward end, a rearward end and a pair of opposite sides which extend between the forward and rearward ends of the trailer frame. In addition, the pulling vehicle includes a ball mount, and the trailer includes a ball-accepting coupler which is securable to the ball mount for hitching the trailer to the pulling vehicle.

The hitch system includes means disposed adjacent the forward end of the trailer for defining an elongated guideway which is supported by the trailer in an angular relationship with respect to the horizontal. Moreover, the hitch system includes a first portion which cooperates with the guideway of the guideway-defining means for movement along the length thereof and a second portion which is adapted to support a ball-accepting coupler secured thereto so that by securing a ball-accepting coupler to the second portion of the adapter and moving the first portion of the adapter along the length of the guideway, the ball-accepting coupler can be positioned at any of a number of alternative horizontal levels relative to the ball mount of the pulling vehicle. The hitch system also includes means for releasably securing the first portion of the adapter at a fixed location along the length of the guideway to thereby fixedly secure the ball-accepting coupler at a desired horizontal level relative to the ball mount of the pulling vehicle to facilitate the coupling of the ball-accepting coupler to the ball mount of the pulling vehicle.

### BRIEF DESCRIPTION OF THE DRAWINGS

FIG. 1 is a perspective view of a trailer having a hitch system which embodies features of the present invention and a fragment of a pulling vehicle to which the hitch system can be coupled for trailer-pulling purposes.

FIG. 2 is a perspective view of an exemplary vehicle with which the FIG. 1 trailer can be pulled, shown exploded, and a fragment of the FIG. 1 trailer.

FIG. 3 is a perspective view of a fragment of the FIG. 1 trailer and hitch system, shown exploded.

FIG. 4 is a side elevation view of the FIG. 3 fragment as seen generally from the left in FIG. 3.

FIG. 5 is a side elevation view of a fragment of the hitch system of the FIG. 1 trailer like that of FIG. 4 and a fragment of the pulling vehicle of FIG. 2 to which the FIG. 1 trailer is desired to be coupled.

FIG. 6 is a perspective view of a alternative scheme for securing the adapter and the guideway-providing means of the hitch system together.

### DETAILED DESCRIPTION OF AN ILLUSTRATIVE EMBODIMENT

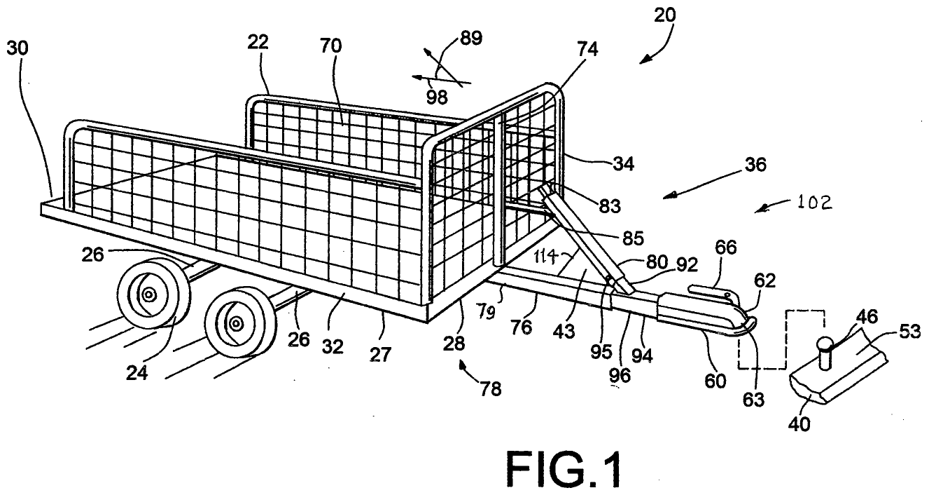

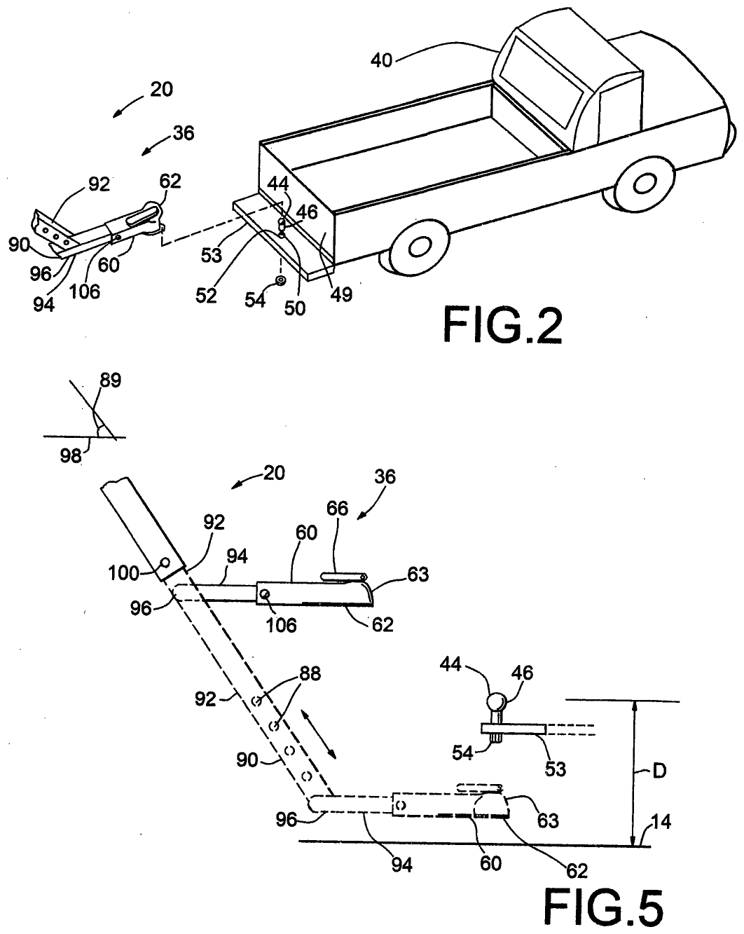

Turning now to the drawings in greater detail and considering first FIG. 1, there is illustrated an embodiment, generally indicated 20, of a trailer including a hitch system, generally indicated 36, within which features of the present invention are incorporated. Briefly, the trailer 20 includes a wheeled, open-top cargo, or receptacle, portion 22 within which a load to be carried by the trailer 20 can be positioned and a set of ground-engaging wheels 24 which are each rotatably mounted upon an axle 26 arranged beneath the cargo portion 22 of the trailer 20. The cargo portion 22 includes a frame 27 having a forward end 28, a rearward end 30 and a pair of opposite sides 32, 34 which extend between the forward and rearward ends 28, 30 of the trailer frame 27. As will be apparent herein, the hitch system 36 of the trailer 20 enables the trailer 20 to be coupled, or hitched, to a pulling vehicle 40 (FIG. 2) for purposes of pulling the trailer 20 behind the vehicle 40.

With reference to FIG. 2, there is shown an exemplary vehicle 40 of a class capable of pulling the trailer 20 behind the vehicle 40 with the hitch system 36. The depicted FIG. 2 (pulling) vehicle 40 is a pickup truck, but alternatively, the pulling vehicle could be any of a number of other classes of vehicles, such as a tractor, an all terrain vehicle (ATV) or a golf cart. As will be apparent herein, the hitch system 36 of the depicted FIG. 1 trailer 20 is envisioned to cooperate with, or be coupled to, the ball portion 44 of a trailer ball mount 46 which is appropriately secured to a horizontally-disposed rear bumper, indicated 53 in FIG. 2, associated with the rearward end, indicated 49 in FIG. 2, of the vehicle 40. Accordingly and by way of example, the ball mount 46 can include a ball portion 44 and a threaded stem 50 (FIG. 2) which depends downwardly from the ball portion 44. The threaded stem 50 can be inserted through a pre-formed opening 52 provided within the rear bumper 53 of the vehicle 40, and a nut 54 is threadably secured about the stem 50 of the ball portion 44 to fixedly secure the trailer ball mount 46 to the vehicle rear bumper 53.

With the trailer ball mount 46 thereby secured to the rear bumper, 53 of the vehicle 40, the ball portion 44 of the ball mount 46 is in condition to cooperate with an elongated trailer coupler 60 (FIGS. 1-4) which forms a component of the hitch system 36 described herein. In this connection and with reference again to FIGS. 1-4, the coupler 60 includes a forwardly-disposed ball-accepting portion 62 disposed adjacent one end, or the forward end, indicated 63, of the coupler 60 and an opposite rearward end portion 67 of substantially channel-shaped cross section. Associated with the ball-accepting portion 62 is a manually-movable lever member 66 and a ball-capturing wedge portion (not shown) which is positioned within an internal cavity of the ball-accepting portion 62 and is joined to the lever member 66 through the body of the coupler 60. The components of the coupler 60 are well known in the art so that a detailed description of them is not believed to be necessary. Suffice it to say that by manipulating, or pivoting, the lever member 66 relative to the body of the coupler 60 in one direction (e.g. upwardly) so that the ball-accepting portion 62 of the coupler 60 can be positioned downwardly about the ball portion 44 of the ball mount 46 and then manipulating, or pivoting, the level member 66 in the opposite direction (e.g. downwardly) relative to the body of the coupler 60 positions the ball-capturing wedge portion in a condition which captures the ball portion 44 of the ball mount 46 within the internal cavity of the ball-accepting portion 62.

With reference again to FIG. 1, the frame 27 of the trailer 20 includes an arrangement, generally indicated 78, of horizontally and vertically-disposed struts comprised, for example, of steel angle iron which provides the trailer frame 27 with a strong framework. One horizontally-oriented strut, indicated 79 in FIG. 1, of such an arrangement 78 of struts provides a tongue 76 for the trailer 20, and one vertically-oriented strut, indicated 74, of the arrangement 78 is disposed substantially centrally of the trailer 20 adjacent the forward end 28 thereof. As will be apparent herein, the hitch system 36 of the trailer 20 is supported, in part, by the vertically-disposed strut 74 of this arrangement 78 of struts. In addition, a fence-like mesh 70 surrounds at least three sides of the trailer frame 27 to provide sides and a front for the cargo portion 22 of the trailer 20.

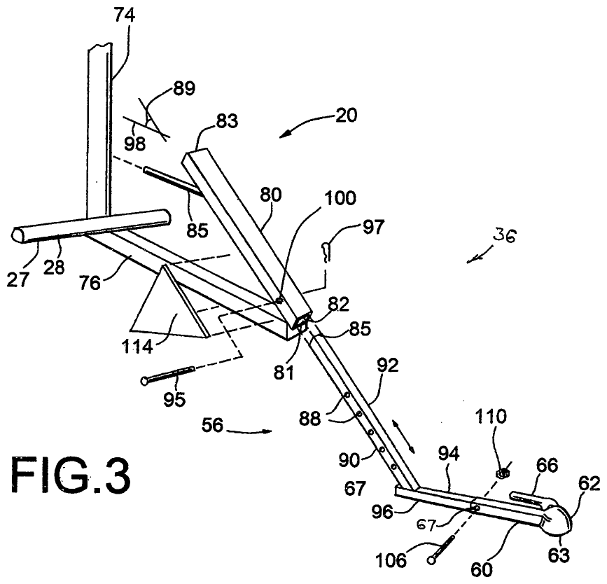

Meanwhile and with reference to FIG. 3, hitch system 36 includes an elongated sleeve member 80 comprised, for example, of steel and which is joined to the frame 27 of the trailer 20 adjacent the forward end 28 thereof. The elongated sleeve member 80 possesses a substantially square cross section and has two opposite forward and rearward ends 82 and 83, respectively, and a hollow interior 81 which extends between the opposite ends 82, 83. The forward end 82 of the sleeve member 80 is open for slidably accepting an elongated portion 92 of an adapter 90 (described herein). Moreover, the sleeve member 80 is fixedly secured (as by welding) to the vertically-oriented strut 74 of the trailer frame 27 by way of a horizontally-extending strut 85 so that the sleeve member 80 is fixedly arranged at about an angle, indicated 89 in FIGS. 1, 3 and 5, of about forty-five degrees with respect to the horizontal, indicated 98 in FIGS. 1, 3 and 5. The aforementioned strut 85 is welded at one of its ends to the sleeve member 80 and is welded at the other of its ends to the vertically-oriented strut 74 of the arrangement 78 for rigidly securing the elongated sleeve member 80 in the aforedescribed angular relationship with respect to the horizontal 98. With the sleeve member 80 thereby arranged adjacent the forward end 28 of the receptacle portion 22 of the trailer 20, one, or the forward, end 82 of the sleeve member 80 opens substantially forwardly of the trailer 20 and downwardly relative to the horizontal 98 at about a forty-five degree angle. It follows that the sleeve member 80 is thereby stably and fixedly supported in a stationary condition with respect to the frame 27 of the trailer 20. To further rigidify and brace the sleeve member 80 adjacent the forward end 28 of the trailer 20, a triangular-shaped plate 114 (FIG. 3) can be welded along two of its edges to the sleeve member 80 and to the tongue 76 of the trailer 20.

It follows from the foregoing that the forward, and open, end 82 of the sleeve member 80 is disposed adjacent the forward end 28 of the trailer frame 27, and the rearward end 83 of the sleeve member 80 extends rearwardly of the forward end 28.

In addition, the hitch system 36 also includes a substantially V-shaped adapter 90 (best shown in FIG. 3) which includes two elongated portions 92, 94 (e.g. of substantially square cross section) which are joined (e.g. welded) to one another at an apex 96 to provide the adapter 90 with its substantially V-shaped form. One portion 92 (of the two elongated portions 92, 94 is adapted to be slidably accepted (endwise) by the hollow interior 81 of the sleeve member 80 by way of the forward, or open, end 82 thereof for sliding movement relative to and along the length of the sleeve member 80 in somewhat of a telescoping fashion.

It is also a feature of the hitch system 36 that it includes means, generally indicated 56 in FIG. 3, for securing the elongated portion 92 of the adapter 90 at a desired position along the length of the sleeve member 80. Within the depicted hitch system 36, the securing means 56 is in the form of a pin, or bolt 95, having an elongated shank 58 which can be accepted by aligned openings (described herein) which have been pre-formed in the elongated portion 92 and the sleeve member 80. More specifically and with reference to FIG. 3, the elongated portion 92 is provided with a series of transversely-extending pre-formed openings 88 which extend between the opposite sides thereof, and the sleeve member 80 is provided with a single opening 100 which extends transversely therethrough at a location disposed adjacent the forward, or open, end 82 thereof. By positioning the elongated portion 92 of the adapter 90 along the length of the sleeve member 80 so that one of the series of openings 88 provided along the length of the elongated portion 92 is aligned with the opening 100 provided within the sleeve member 80, the aligned openings 88, 100 are in condition for accepting the shank of the bolt 95 inserted endwise therethrough to thereby secure the elongated portion 92 in a fixed position along the length of the sleeve member 80. The bolt 95, in turn, can be secured through the aligned openings 88, 100 by way of a cotter key 97 (FIG. 3) or other suitable fastener which is securable to the free end of the shank of the pin 95.

Meanwhile and with reference still to FIG. 3, the ball-accepting coupler 60 is secured to the elongated portion 94 of the adapter 90 to fixedly join the coupler 60 to the adapter 90. To this end, the body of the coupler 90 is positioned about the elongated portion 94 so that the forward end 63 of the coupler 60 extends forwardly of the elongated member 94, and each of the coupler 90 and elongated portion 94 and is provided with a preformed opening capable of being aligned with a transversely-extending opening which has been pre-formed within the body of the coupler 60. The shank of a bolt 106 is directed endwise through these aligned openings of the coupler 90 and elongated portion 94, and the bolt 106 is secured through these aligned openings with a nut 110 (FIG. 3) which is threaded about the free end of the bolt 106 to secure the coupler 60 in a stationary condition along the length of the elongated member 94.

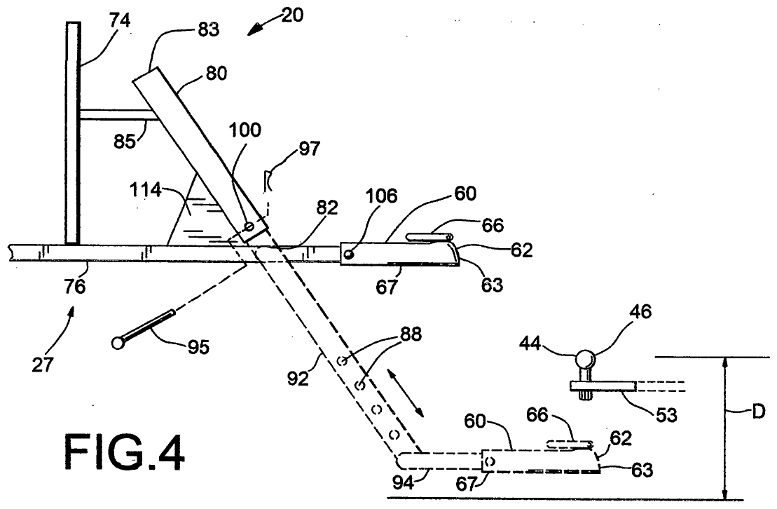

With reference to FIGS. 1, 3 and 4 and with the elongated member 92 of the adapter 90 being accepted by the open end 82 of the sleeve member 80, the body of the coupler 90 is arranged somewhat horizontally (as best depicted in FIG. 4) at which the body of the coupler 90 is arranged substantially horizontally.

It follows that by shifting the elongated portion 92 of the adapter 90 in position along the length of the sleeve member 80, the ball-accepting portion 62 of the coupler 60 relative to the horizontal is altered accordingly. For example and with reference to FIGS. 4 and 5, by removing the pin 95 from the aligned openings 100 and 88, the horizontal disposition of the ball-accepting portion 62 of the coupler 60 can be shifter between, for example, the horizontal disposition of the ball-accepting portion 62 depicted in solid lines in FIG. 4 and the horizontal disposition of the ball-accepting portion 62 depicted in phantom in FIG. 4.

The aforedescribed hitch system 36 facilitates a prompt and relatively easy adjustment in the height (i.e. the distance D above the ground) at which the coupler 60 is positioned, and such a feature can be readily appreciated when hitching the trailer 20 to the ball mount 46 of the FIG. 2 vehicle 40 when the ball mount 46 is disposed at a substantially different (e.g. horizontal) elevation than is the ball-accepting portion 62 of the coupler 60 of the trailer 20. For example, there is depicted in FIG. 5 a view of the ball portion 44 of the ball mount 46 (mounted upon the rear bumper 53 of the vehicle 40) when the top of the ball portion 44 is disposed a distance D above the surface of the underlying ground 14. Meanwhile, the ball-accepting portion of the coupler 60 of the hitch system 36 (when in its elevated, or its depicted solid-line, position) is disposed a considerable distance in excess of the distance D. Such a difference would ordinarily render it difficult to hitch the ball-accepting portion 62 of the coupler 60 to the ball portion 44 by manually manipulating the ball-accepting portion 62 of the coupler 60 downwardly over the ball portion 44 of the ball mount 46. However, by removing the pin 95 from the aligned openings 100, 88 of the sleeve member 80 and the elongated portion 92 of the adapter 90 (so that the adapter 90 is no longer pinned to the sleeve member 80) and thereafter shifting the elongated member 92 downwardly relative to and along the sleeve member 80, the ball-accepting portion 62 of the coupler 60 can be moved, or guided, downwardly along the hollow interior 81 of the sleeve member 80 to an elevation closer to that of the ball portion 44. Once the coupler 60 is disposed at a suitable, or more desirable, elevation for coupling the coupler 60 to the ball portion 44 of the ball mount 46, the elongated portion 92 of the adapter 90 is directed endwise through a newly-aligned set of openings 100, 88 to re-secure the elongated portion 92 of the adapter 90 along the length of the sleeve member 80. With the ball-accepting portion 62 of the coupler 60 thereby secured in a stationary condition relative to the remainder of the trailer 20 and at an elevation closer to that of the ball portion 44 of the ball mount 46, the elongated portion 92 of the adapter 90 can be more easily manipulated downwardly about the ball portion 44 for coupling the coupler 60 to the ball mount 46.

It follows that a trailer hitch system 36 has been described which includes a ball mount 46 and a ball-accepting 62 portion of a coupler 60 which is securable to the ball mount 46. The hitch system 36 comprises a guideway-defining means, generally indicated 102 in FIG. 1, in the form of the aforedescribed elongated sleeve member 80 whose hollow interior 81 provides a linear guideway along the length thereof. The sleeve member 80 is fixedly secured to the wheeled frame 27 of the trailer 20 adjacent the forward end 28 thereof. The elongated sleeve member 80 has an open end 82 and a hollow interior 81 which extends (rearwardly) along the sleeve member 80 from the open end 82 thereof and is arranged in such a relation to the trailer 20 so that the open end 82 of the sleeve member 80 opens substantially forwardly of the frame 27 and downwardly relative to the horizontal 98 (FIGS. 1, 3 and 5) at about a forty-five degree angle 89 (FIGS. 1, 3 and 5). An adapter 90 having two elongated portions 92, 94 is joined to one another at an apex 96 to provide the adapter 90 with a substantially V-shape; and one elongated portion 92 of the adapter 90 is slidably accepted by the hollow interior 81 of the elongated sleeve member 80 for sliding movement therealong. Meanwhile, the other elongated portion 94 of the adapter 90 is adapted to support the ball-accepting portion 62 of the trailer coupler 60 in a stationary condition therewith. Therefore and by fixedly securing the trailer coupler 60 to the elongated portion 94 of the adapter 90 and slidably moving the one elongated portion 92 endwise along the hollow interior of the sleeve member 80, the ball-accepting portion 62 of the coupler 60 can be positioned at any of a number of alternative horizontal levels. Means, in the form of a bolt or pin 95, is provided for releasably securing the one elongated portion 92 of the adapter 90 at a fixed position along the length of the sleeve member 80 to thereby fixedly (and releasably) secure the coupler 60 at a desired horizontal elevation relative to the underlying ground 14 (FIG. 5) to facilitate the coupling, or hitching, of the trailer 20 to the ball mount 46 of the pulling vehicle 40. Once hitched to the ball mount 46, the trailer 20 can be pulled with the pulling vehicle 40.

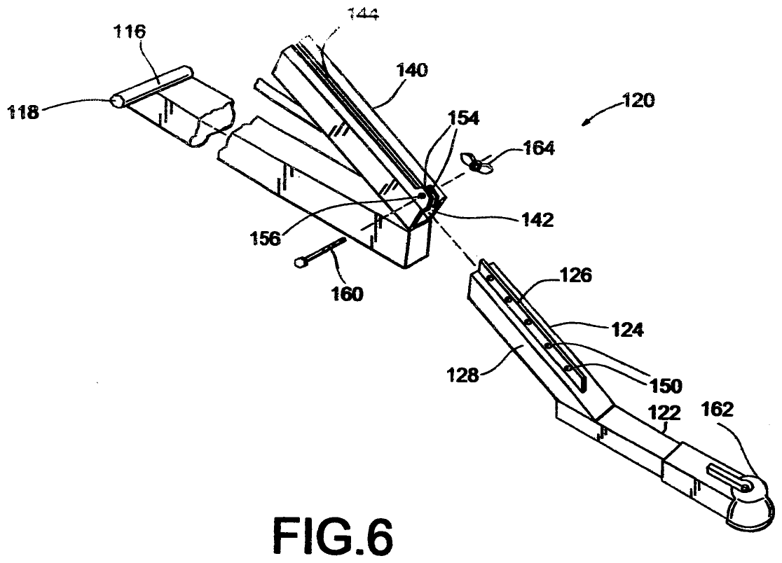

With reference to FIG. 6, the trailer hitch system 36 can alternatively be described in connection with the vertical midplane of the trailer 20. In particular, the vertical mid-plane of the FIG. 1 trailer 20 is located substantially midway between the opposite sides 32, 34 of the trailer frame 27 and extends between the forward and rearward ends 28 and 30 thereof. Meanwhile, the elongated (and linear) guideway defined by the hollow interior 81 of the sleeve member 80 is oriented substantially within the aforedescribed midplane of the trailer 20. Arranged in such a midplane, the rearward end 84 of the sleeve member 80 extends rearwardly of the forward end 82 thereof at about a forty-five degree angle 89 relative to the horizontal 98 (FIGS. 1, 3 and 5)

Although the aforedescribed hitch system 36 has been shown and described as including an elongated sleeve member 80 whose opening 100 can be selectively aligned with a pre-formed opening 88 (defined within the elongated member 92) so that the aligned openings 88 and 100 can accept the shank of a bolt or pin 95 directed therethrough for pinning the adaptor 90 and sleeve member 80 together, alternative schemes for pinning the adaptor 90 to the sleeve member 80 can be had.

For example, there is depicted in FIG. 6 an alternative hitch system, generally indicated 120, embodied within a trailer 118. The hitch system 120 includes an adapter 122 having an adapter 122 having an elongated portion 124 which is provided with an upturned fin, or flange 126, which is attached to so as to extend along the length of the upper surface, indicated 128, of the adapter 122 and which is capable of being pinned to the frame, indicated 116, of the trailer 118. The adapter 122 also includes a second elongated portion 125 which is joined to the elongated portion 124 to provide the adapter 122 with a substantially V-shape and to support a ball-accepting coupler 162 secured adjacent a (forward) end of the elongated portion 125. Meanwhile, the trailer 118 includes a hollow sleeve member 140 which is attached, as with welds, to the trailer frame 116 in a stationary relationship therewith so that the forward, or open, end 142 of the sleeve member 140 opens downwardly and forwardly of the trailer frame 116 at an angle of about forty-five degrees with respect to the horizontal. Moreover, the upper surface of the sleeve member 140 is provided with a through-slot 144 which extends along the length of the sleeve member 140 for slidably accepting the elongated flange 126 of the adapter 122 when the elongated portion 124 of the adapter 122 is directed endwise into the hollow interior of the sleeve member 140 by way of the open end 142 thereof for sliding movement therealong. In addition, the flange 124 is provided with a series of openings 150 which extend transversely of the flange 124, and a pair of flange-like bosses 154 are joined to the sleeve member 140 so as to expend upwardly thereof and so that the bosses 154 are arranged on opposite sides of the through-slot 144. When the hitch system 120 is assembled, the elongated portion 124 is slidably positioned along the length of the hollow interior of the sleeve member 140, and the flange 126 of the adapter 122 is positioned within for movement along the length of the through-slot 144.

In addition, the pair of flange-like bosses 154 are provided with aligned through-openings 156 which extend transversely therethrough and can be selectively aligned with any of the series of openings 150 of the flange 126 for accepting the shank of a bolt 160 directed therethrough. In other words, by shifting the elongated portion 126 of the adapter 122 along the length of the sleeve member 140 to thereby position a ball-accepting coupler 162 (which is fixedly secured to the elongated portion 125 of the adapter 122), at a desirable height (relative to the ball mount (not shown) to which the ball-accepting coupler 162 is desired to be hitched) and then aligning the through-openings 156 of the bosses 154 with an appropriate opening 150 provided along the length of the flange 126 of the sleeve member 140, the shank of the bolt 160 can be directed through aligned openings 156 and 151 to thereby pin the adapter 122 to the sleeve member 140. A suitable nut, or wing nut 164, can be secured about the (threaded) end of the bolt 160 to prevent the inadvertent withdrawal of the bolt 160 from the aligned openings 156, 150.

It will be understood that numerous modifications and substitutions can be had to the aforedescribed embodiments 36 and 120 of the hitch system 36 or 120 without departing from the spirit of the invention. Accordingly, the aforedescribed embodiments 36 and 120 are intended for the purpose of illustration and not as limitation.

1. A hitch system for hitching a trailer to a pulling vehicle wherein the trailer includes a wheeled frame having a forward end, a rearward end and a pair of opposite sides which extend between the forward and rearward ends of the trailer frame, and the pulling vehicle includes a ball mount and the trailer includes a ball-accepting coupler which is securable to the ball mount for hitching the trailer to the pulling vehicle, the hitch system comprising:
means disposed adjacent the forward end of the trailer for defining an elongated guideway which is supported by the trailer in an angular relationship with respect to the horizontal;
an adapter having a first portion which cooperates with the guideway of the guideway-defining means for movement along the length thereof and a second portion which is adapted to support a ball-accepting coupler secured thereto so that by securing a ball-accepting coupler to the second portion of the adapter and moving the first portion of the adapter along the length of the guideway, the ball-accepting coupler can be positioned at any of a number of alternative horizontal levels relative to the ball mount of the pulling vehicle; and
means for releasably securing the first portion of the adapter at a fixed location along the length of the guideway to thereby fixedly secure the ball-accepting coupler at a desired horizontal level relative to the ball mount of the pulling vehicle to facilitate the coupling of the ball-accepting coupler to the ball mount of the pulling vehicle.

2. The hitch system as defined in claim 1 wherein the trailer includes a vertical mid-plane which extends between the forward and rearward ends of the trailer frame, and
the elongated guideway is substantially arranged in the vertical mid-plane of the trailer frame.

3. The hitch system as defined in claim 2 wherein the elongated guideway includes a forward end and an opposite rearward end which extends rearwardly of the forward end of the guideway so that the forward end of the guideway is disposed at a horizontal level which is below that of the rearward end of the guideway.

4. The hitch system as defined in claim 3 wherein the rearward end of the guideway extends upwardly and rearwardly from the forward end of the guideway at about a forty-five degree angle with respect to the horizontal.

5. The hitch system as defined in claim 3 wherein the guideway is substantially linear as a path is traced between the forward and rearward ends of the guideway.

6. The hitch system as defined in claim 1 wherein the elongated guideway is in the form of an elongated sleeve member having an open end disposed adjacent the forward end of the trailer frame and a hollow interior which extends along the sleeve member from the open end thereof, and wherein the elongated sleeve member is fixedly secured to the trailer so that the open end of the sleeve member opens substantially forwardly of the trailer and downwardly relative to the horizontal at about a forty-five degree angle, and
wherein the first portion of the adapter is elongated in form and is adapted to be accepted by the hollow interior of the elongated sleeve member through the open end thereof for sliding movement along the length of the sleeve member.

7. The hitch system as defined in claim 6 wherein the elongated sleeve member has a forward end which is disposed adjacent the forward end of the trailer frame and an opposite rearward end, and the sleeve member is substantially linear as a path is traced between the forward and rearward ends of the sleeve member.

8. The hitch system as defined in claim 1 wherein the means for releasably securing the elongated portion of the adapter at a fixed location along the length of the guideway includes a pin for securing the elongated portion of the adapter to the guideway-defining means.

9. A hitch system for hitching a trailer to a pulling vehicle wherein the trailer includes a wheeled frame having a forward end, a rearward end and a pair of opposite sides which extend between the forward and rearward ends, and the pulling vehicle includes a ball mount and the trailer includes a ball-accepting coupler which is securable to the ball mount for hitching the trailer to the pulling vehicle, the hitch system comprising:
a mounting assembly including means defining an elongated guideway having two opposite ends and which is fixedly secured to the trailer so that the guideway of the guideway-defining means is oriented at about a forty-five degree angle relative to the horizontal;
an adapter having an elongated portion which is associated with the mounting assembly for movement along the elongated guideway of the guideway-defining means between the two opposite ends of the guideway, and the adapter is adapted to support a ball-accepting coupler secured thereto so that by securing a ball-accepting coupler to the adapter and shifting the elongated portion of the adapter between the two opposite ends of the guideway of the guideway-defining means, the coupler can be positioned at any of a number of alternative horizontal levels relative to the ball mount of the pulling vehicle; and
means for releasably securing the elongated portion of the adapter at a fixed location between the two opposite ends of the guideway to thereby fixedly secure the coupler at a desired horizontal level relative to the ball mount to facilitate the coupling of the trailer coupler to the ball mount.

10. The hitch system as defined in claim 9 wherein the guideway-defining means is in the form of an elongated sleeve member having an open end a hollow interior which extends along the sleeve member from the open end thereof and wherein the elongated sleeve member is fixedly secured to the trailer frame so that open end of the sleeve member opens substantially forwardly of the trailer frame and downwardly relative to the horizontal at about a forty-five degree angle;
and wherein the elongated portion of the adapter is positioned within the hollow interior of the sleeve member for sliding movement therealong.

11. The hitch system as defined in claim 9 wherein the means for releasably securing the elongated portion of the adapter at a fixed location between the two opposite ends of the guideway includes a pin for fixedly securing the elongated portion of the adapter to the guideway-defining means and at a desired horizontal level for purposes of coupling the trailer coupler to the ball mount.

12. The hitch system as defined in claim 9 wherein the trailer includes a vertical mid-plane which extends between the forward and rearward ends of the trailer frame, and
the elongated guideway is substantially arranged in the vertical mid-plane of the trailer frame.

13. The hitch system as defined in claim 12 wherein the elongated guideway includes a forward end which is arranged adjacent the forward end of the trailer frame and an opposite rearward end which extends rearwardly of the forward end of the guideway so that the forward end of the guideway is disposed at a horizontal level which is below that of the rearward end of the guideway.

14. The hitch system as defined in claim 13 wherein the rearward end of the guideway extends upwardly and rearwardly from the forward end of the guideway at about a forty-five degree angle with respect to the horizontal.

15. The hitch system as defined in claim 9 wherein the means for releasably securing the elongated portion of the adapter at a fixed position between the two opposite ends of the guideway includes a pin for fixedly securing the elongated portion of the adapter to the guideway-defining means and at a desired horizontal level for purposes of coupling the trailer coupler to the ball mount of the pulling vehicle.

16. The hitch system as defined in claim 9 wherein the guideway-defining means is in the form of an elongated sleeve member having an open end and a hollow interior which extends along the sleeve member from the open end thereof, and wherein the elongated sleeve member is fixedly secured to the trailer so that the open end of the sleeve member opens substantially forwardly of the trailer and downwardly relative to the horizontal at about a forty-five degree angle, and
wherein the elongated portion of the adapter is adapted to be accepted by the hollow interior of the adapter through the open end thereof for sliding movement along the hollow interior thereof in somewhat of a telescoping fashion.

17. The hitch system as defined in claim 9 wherein the guideway of the guideway-defining means is substantially linear as a path is traced between the opposite ends of the guideway.

18. The hitch system as defined in claim 9 wherein one of the guideway-defining means and the first portion of the adapter defines a series of through-openings and the other of the guideway-defining means and the first portion of the adapter defines one through-opening, and the first portion of the adapter is positionable along the length of the guideway so that the one through-opening is aligned with one of the series of through-openings, and the means for releasably securing includes a pin having a shank which is positionable through the aligned one through-opening and the one of the series of through-openings for pinning the adapter to the guideway-defining means.

19. The hitch system as defined in claim 9 wherein the elongated portion of the adapter is a first elongated portion, and the adapter includes a second elongated portion which is joined to the first elongated portion to provide the adapter with a substantially V-shape; and
wherein the first elongated portion of said adapter is accepted by the hollow interior of the elongated sleeve member for sliding movement therealong and wherein the second elongated portion of the adapter is adapted to support a ball-accepting coupler secured thereto so that by securing a ball-accepting coupler to the second elongated portion of said adapter and inserting the first elongated portion of the adapter endwise into the hollow interior of the sleeve member through the open end thereof, the horizontal disposition of the relative to the ball mount can be altered.

20. The hitch system as defined in claim 19 wherein one of the guideway-defining means and the first elongated portion of the adapter defines a series of through-openings and the/other of the guideway-defining means and the first elongated portion of the adapter defines one through-opening, and the first elongated portion of the adapter is positionable along the length of the guideway so that the one through-opening is aligned with one of the series of through-openings, and the means for releasably securing includes a pin having a shank which is positioned through the aligned one through-opening and the one of the series of through-openings for pinning the adapter to the guideway-defining means.
